(19) United States
(12) Patent Application Publication
(10) Pub. No.: US 2016/0070770 A1
(43) Pub. Date: Mar. 10, 2016

(54) SUGGESTING SOCIAL GROUPS FROM USER SOCIAL GRAPHS

(71) Applicant: GOOGLE INC., Mountain View, CA (US)

(72) Inventors: Jianming He, Cupertino, CA (US); Yuguang Wu, Santa Clara, CA (US)

(73) Assignee: GOOGLE INC., Mountain View, CA (US)

(21) Appl. No.: 13/663,372

(22) Filed: Oct. 29, 2012

(51) Int. Cl. G06F 17/30

(52) U.S. Cl. CPC G06F 17/30572; G06F 17/30598; G06F 17/30958

(57) ABSTRACT

A system and computer-implemented method for suggesting social groups is provided. Direct contacts connected to a user of a social networking service are identified. Secondary contacts are further identified, where each of the secondary contacts is connected to at least one of the direct contacts. A set of direct contacts is determined from the direct contacts based on connections between the direct contacts and the secondary contacts. The set of direct contacts is provided as a suggested social group.

### BACKGROUND

Social networking services operate on the premise that individual users have a number of contacts with whom the user may want to share information such as blog entries, photographs, web links, and other electronic information. In some instances, however, the user may want to share certain information only with a subset of the contacts. In order to be able to do so effectively, contacts may be assigned to a variety of social groups, and information may be shared with a particular social group. Assigning each contact to the variety of social groups, however, may be overwhelming to users who have hundreds or even a thousand or more contacts.

### SUMMARY

The disclosed subject matter relates to a computer-implemented method for suggesting social groups. Direct contacts connected to a user of a social networking service are identified. Secondary contacts are further identified, where each of the secondary contacts is connected to at least one of the direct contacts. A set of direct contacts is determined from the direct contacts based on connections between the direct contacts and the secondary contacts. The set of direct contacts is provided as a suggested social group.

These and other aspects can include one or more of the following features. Identifying the direct contacts may include indentifying contacts that are one hop away from the user on the social networking service, and identifying the secondary contacts may include indentifying contacts that are two hops away from the user on the social networking service. Additionally, determining the set of direct contacts may include identifying direct contacts that share a number of the secondary contacts above a predetermined threshold.

Determining the set of direct contacts based on the secondary contacts may also include performing a frequent itemset mining analysis on the secondary contacts in relation to the direct contacts. An inverted index for indicating support values for all possible combinations of direct contacts may be generated, where performing a frequent itemset mining analysis on the secondary contacts in relation to the direct contacts includes performing a frequent itemset mining analysis on the generated inverted index.

In some aspects, determining the set of direct contacts based on connections between the direct contacts and the secondary contacts may include identifying two or more direct contacts with a corresponding support value greater than a predetermined threshold, and may also include identifying two or more direct contacts with a number of common contacts greater than a predetermined value. Determining the set of direct contacts based on the secondary contacts may further include identifying, from all sets of direct contacts with a corresponding support value greater than a predetermined threshold, a set with a highest number of direct contacts or a set with a number of direct contacts greater than a predetermined minimum number of contacts.

The disclosed subject matter also relates to a machine-readable medium comprising instructions stored therein, which when executed by a system, cause the system to perform operations including identifying direct contacts connected to a user of a social networking service, where the direct contacts do not have associations with a social group. Secondary contacts are identified, where each of the secondary contacts is connected to at least one of the direct contacts. A frequent itemset mining analysis is performed on the secondary contacts in relation to the direct contacts. One or more sets of direct contacts are determined from the direct contacts based on the performed frequent itemset mining analysis. The one or more sets of direct contacts are provided as suggested social groups.

These and other aspects can include one or more of the following features. Identifying the direct contacts may include indentifying contacts that are one hop away from the user on the social networking service, and identifying the secondary contacts may include indentifying contacts that are two hops away from the user on the social networking service. Each of the secondary contacts is not directly connected to the user. Additionally, an inverted index for indicating support values for all possible combinations of direct contacts may be generated, where performing a frequent itemset mining analysis on the secondary contacts in relation to the direct contacts includes performing a frequent itemset mining analysis on the generated inverted index. The support value identifies a percentage of common contacts of the secondary contacts shared by two or more direct contacts. Determining the one or more sets of direct contacts based on the performed frequent itemset mining analysis may also include identifying one or more sets of direct contacts with corresponding support values greater than a predetermined threshold. Determining the one or more sets of direct contacts based on the performed frequent itemset mining analysis may further include identifying, from the one or more sets, a set with a number of direct contacts greater than a predetermined value. In some aspects, the support value corresponds to the number of secondary contacts commonly shared by the direct contacts.

The machine-readable medium may also include instructions for receiving a response for the suggested social groups and creating one or more new social groups based on the suggested groups when an affirmative response is received. When a negative response is received, the response may be stored in a memory. When one or more sets of direct contacts are to be provided as suggested social groups, a check is made on the memory. The one or more sets of direct contacts are provided as the suggested social groups only when no stored negative responses corresponding to the suggested social groups are identified.

The disclosed subject matter further relates to a system that includes one or more processors and a machine-readable medium comprising instructions stored therein, which when executed by the processors, cause the processors to perform operations including identifying direct contacts connected to a user of a social networking service, where each of the direct contacts is one hop away from the user on the social networking service. Secondary contacts are further identified, where each of the secondary contacts is connected to at least one of the direct contacts, and where each of the secondary contacts is two hops away from the user on the social networking service. A set of direct contacts is determined from the direct contacts based on connections between the direct contacts and the secondary contacts. The set of direct contacts is compared with direct contacts of a preexisting social group. The set of direct contacts is provided as a suggested addition to the preexisting social group when the set of direct contacts overlaps with direct contacts of the preexisting social group by a predetermined percentage.

These and other aspects can include one or more of the following features. Determining the set of direct contacts based on connections between the direct contacts and the secondary contacts includes performing a frequent itemset mining analysis on the secondary contacts in relation to the direct contacts. An inverted index for indicating support values for all possible combinations of direct contacts is generated, where determining the set of direct contacts based on the secondary contacts further includes identifying a set of direct contacts with a corresponding support value greater than a predetermined threshold.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for providing a suggested social group in a social networking service.

FIG. 2 illustrates an example of a server system for providing a suggested social group in a social networking service.

FIG. 3 illustrates an example method for providing a suggested social group in a social networking service.

FIG. 4 illustrates a graphical representation of determining suggested social groups based on a statistical analysis.

FIG. 5 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

The implementation of social groups in social networking services allows users to organize contacts into different groups (e.g., family, school friends, coworkers, etc.). By organizing contacts into different groups, a user can target a specific audience when sharing content on the social networking service. For example, when a user posts content on a social networking service, the user can select a specific group with whom the user would like to share the content. However, organizing each and every contact into one or more groups may be difficult, particularly when the number of contacts a user is connected to increases. With the integration of social networking services with other applications such as address books and email accounts, which allow users to easily import numerous contacts to the user's social networking account, a user may have hundreds or even a thousand or more contacts.

The disclosed subject matter relates to a computer-implemented method for providing a suggested social group in a social networking service. Direct contacts connected to a user of a social networking service are identified. Secondary contacts are further identified, where each of the secondary contacts is connected to at least one of the direct contacts. In some aspects, direct contacts are identified as contacts that are one hop away from the user, and secondary contacts are identified as contacts that are two hops away from the user. A set of the direct contacts is determined based on connections between the direct contacts and the secondary contacts, and a suggested social group is provided to the user. The user may then either accept or reject the suggestion to edit their social groups, thereby lowering the learning curve for first time and other inexperienced users.

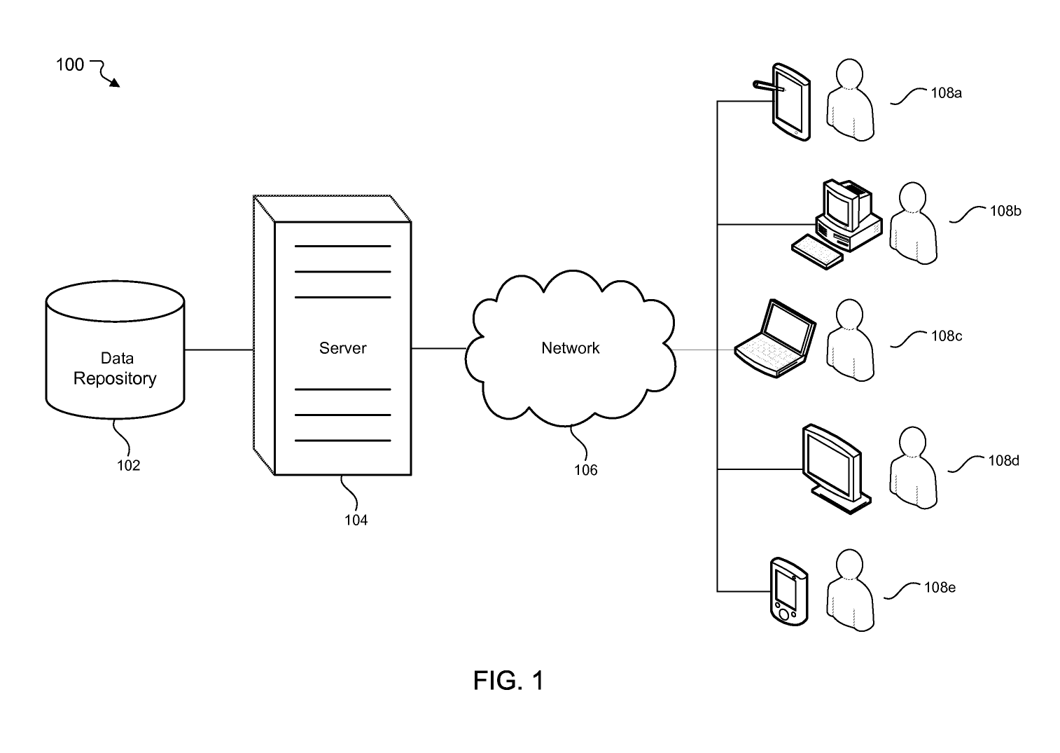

FIG. 1 illustrates an example network environment for providing a suggested social group in a social networking service. Network environment 100 includes data repository 102, server 104, network 106, and client devices 108a-108e. Server 104 and client devices 108a-108e may be communicatively coupled through a network 106, and server 104 may receive requests from client devices 108a-108e. Upon receiving the request, server 104 may retrieve a set of data from data repository 102 and serve the set of data to client devices 108a-108e. For example, when a user logs into a user account on the social networking service, a request to retrieve account and contacts information associated with the user may be sent to the server from one of client devices 108a-108e. The account and contacts information may be retrieved from data repository 102 and served back to the client device, on which the information may be provided to the user.

Data repository 102 may store data corresponding to individual accounts of a social networking service that is accessed by web-based applications. The data may include details related to individual account holders (e.g., name, location, employer, schools attended, etc.), as well as a social graph of the individual account holders (e.g., groups of friends and acquaintances that form a network of associations between the account holders). The data may also include photographs, videos and text entries posted to the individual accounts that may be shared publicly and/or with specific groups of accounts. While the network environment 100 shown in FIG. 1 includes a single data repository 102 and a single server 104, network environment 100 may include additional data repositories and/or servers in some implementations.

Each of client devices 108a-108e represents various forms of processing devices. Examples of a processing device include a desktop computer, a laptop computer, a handheld computer, a television coupled to a processor or having a processor embedded therein, a personal digital assistant (PDA), a network appliance, a camera, a smart phone, a media player, a navigation device, an email device, a game console, or a combination of any these data processing devices or other data processing devices.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

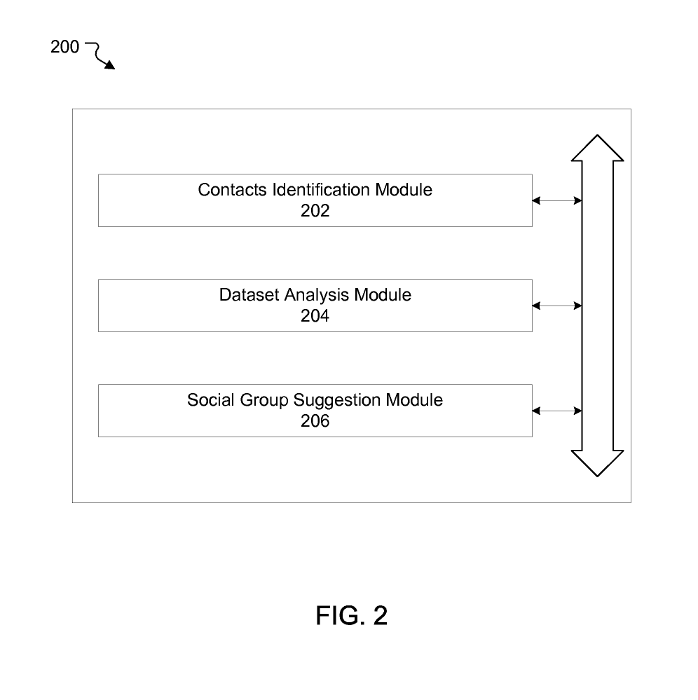

FIG. 2 illustrates an example of a server system for providing a suggested social group in a social networking service. System 200 includes a contact identification module 202, dataset analysis module 204, and a social group suggestion module 206. These modules, which are in communication with one another, process information retrieved from data repository 102 in order to suggest one or more social groups in a social networking service. For example, when a user logs into a user account on the social networking service, contact identification module 202 identifies direct contacts of the user (e.g., contacts corresponding to accounts identified as being connected to the user account in the social networking service). Dataset analysis model 204 then processes the identified direct contacts. The processing of the identified direct contacts may include performing a frequent itemset mining analysis based on the direct contacts and on secondary contacts identified as being connected to at least one of the direct contacts. The frequent itemset mining analysis is used to determine a subset of direct contacts that share common secondary contacts. Once the subset of direct contacts has been determined, social group suggestion module 206 provides the subset of direct contacts as a suggested social group.

In some aspects, the modules may be implemented in software (e.g., subroutines and code). The software implementation of the modules may operate on server 104. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

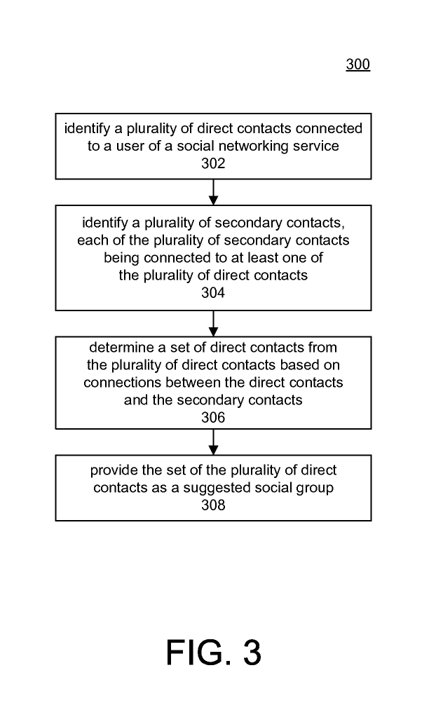

FIG. 3 illustrates an example method for providing a suggested social group in a social networking service. Direct contacts connected to a user of the social networking service are identified in block 302. When a user logs into an account on the social networking service, direct contacts of the user are identified. For example, the user may have several contacts identified as being directly connected to the user. The direct contacts of the user may have been previously imported from an address book or an email account, or manually added by the user. The direct contacts of the user may also have been created by the user accepting a request to connect to another user in the social networking service.

Once the direct contacts have been identified, secondary contacts connected to at least one of the direct contacts are further identified in 304. From the perspective of the user, a contact to which the user account is connected on the social networking service (e.g., a friend's account, a coworker's account, etc.) is identified as a direct contact. A contact that is connected to a direct contact of the user, but to which the user is not directly connected (e.g., a friend of a friend, a coworker of a friend, a friend of a coworker, etc.) is identified as a secondary contact. In some aspects, direct contacts are identified as contacts that are one hop away from the user, and secondary contacts are identified as contacts that are two hops away from the user. Information on the secondary contacts of the user (e.g., name, age, sex, location, etc.), however, is not provided to the user at any time during the process. The information is strictly used to suggest social groups. In some aspects, direct contacts are labeled as first hop contacts, and secondary contacts are labeled as second hop contacts. For the purpose of discussion, the terms direct contact and secondary contacts will be used to describe the relationship of contacts in the social network.

In 306, a set of the direct contacts is determined based on connections between the direct contacts and the secondary contacts. For example, the set of the direct contacts may be determined based on the number of secondary contacts that the set shares. Two or more direct contacts that share a number of secondary contacts (i.e, that are connected to a number of the same secondary contacts) greater than a predetermined threshold suggests that the direct contacts are related; thus, a user may prefer to place these direct contacts in a same group. The set of the direct contacts is then provided as a suggested social group in 308.

In some implementations, a frequent itemset mining analysis is utilized to determine a collection of direct contacts to be suggested as a social group to the target user. A target user, to which the suggested social group is provided, may be connected to two or more direct contacts. Each direct contact that is connected to the target user may be connected to additional contacts to which the target user is not directly connected. The frequent itemset mining analysis provides, for each unique group of direct contacts, a percentage of the total number of additional contacts that the unique group of direct contacts shares with one another. From the percentages that correspond to each unique group of direct contacts, a determination may be made as to which group or groups of direct contacts are to be suggested as a social group. For example, if the target user knows a first contact and a second contact, and the first and second contacts share several common additional contacts that the target user does not know, then a social group including the first and second contacts is likely to be suggested. Conversely, if the first and second contacts don't commonly know additional contacts, then a common social group will not be suggested for the first contact and the second contacts. In other words, the more additional contacts a first and second contact share, the more likely the first and second contacts are to be suggested as a social group.

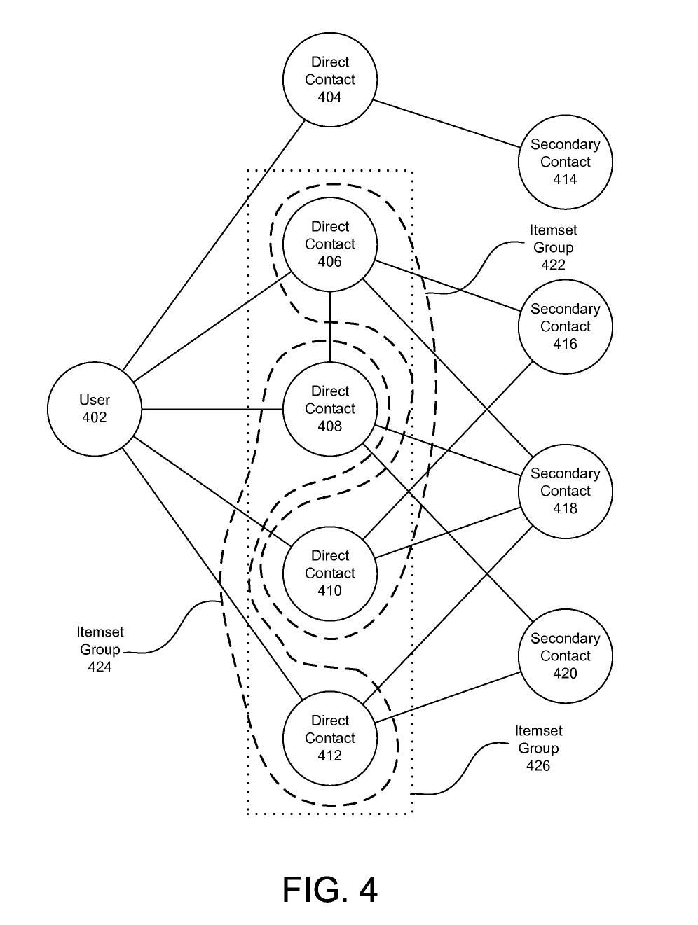

In order to determine which collection of contacts to suggest as a social group, a social graph that identifies the number of common contacts between the contacts is analyzed. FIG. 4 illustrates a graphical representation of a social graph for determining suggested social groups based on a statistical analysis. In the social graph, each node represents a user, and two nodes joined by a line represent two users that are directly connected to one another (e.g., two users that are direct contacts of one another). FIG. 4 illustrates an example social network of target user 402, who has five direct contacts 404, 406, 408, 410, and 412; and four secondary contacts 414, 416, 418, and 420. Direct contacts 404, 406, 408, 410, and 412, and secondary contacts 414, 416, 418, and 420 are also users of the social networking service; thus, contact information for direct contacts 404, 406, 408, 410, and 412 and for secondary contacts 414, 416, 418, and 420 are also known. From this information, direct contact 404 is identified as connected to secondary contact 414; direct contact 406 is identified as connected to secondary contacts 416 and 418; direct contact 408 is identified as connected to direct contact 406 as well as secondary contacts 418 and 420; and direct contact 412 is identified as connected to secondary contacts 418 and 420.

Given this social graph, suggested social groups for target user 402 may be determined by identifying frequent contact sets in direct contacts 404, 406, 408, 410, and 412, for whom secondary contacts 414, 416, 418, and 420 are known. In order to perform the analysis, an inverted index of secondary contacts of target user 402 is built. That is, for each secondary contact, a list of direct contacts to which the target user 402 and the particular secondary contact is connected in the social graph is provided. In this example, the inverted index is as follows:

Secondary Contact 414: Direct Contact 404

Secondary Contact 416: Direct Contacts 406 and 410

Secondary Contact 418: Direct Contacts 406, 408, 410, and 412

Secondary Contact 420: Direct Contacts 408 and 412

Given the inverted index above, contact sets that appear frequently in the inverted index are identified in the frequent itemset mining analysis. Each inverted list can be considered as a “transaction” in the frequent itemset mining analysis, and each direct contact in the list can be treated as an “item”. Many existing algorithms have been proposed for frequent itemset mining (e.g., apriori algorithm, frequent pattern growth algorithm, etc.). While these algorithms generate substantially the same results, the computational cost of the algorithms may vary.

One conceptual application of frequent itemset mining algorithms is called “support”, which is defined as the percentage of transactions that contains all items in an itemset. A predetermined support value threshold may be set, and only sets that have support values higher than the threshold are kept. For example, the support values for the itemsets for the exampled in FIG. 4 are provided as follows:

| Itemset | Support |
|---|---|
| 404 | 1/4 = 25% |
| 406 | 2/4 = 50% |
| 408 | 2/4 = 50% |
| 410 | 2/4 = 50% |
| 412 | 2/4 = 50% |
| 406, 408 | 1/4 = 25% |
| 406, 410 | 2/4 = 50% |
| 406, 412 | 1/4 = 25% |
| 408, 410 | 1/4 = 25% |
| 408, 412 | 2/4 = 50% |
| 410, 412 | 1/4 = 25% |
| 406, 408, 410 | 1/4 = 25% |
| 406, 408, 412 | 1/4 = 25% |
| 406, 410, 412 | 1/4 = 25% |
| 408, 410, 412 | 1/4 = 25% |
| 406, 408, 410, 412 | 1/4 = 25% |

The itemset column indicates the direct contact(s) for which the value in the support column is calculated. For example, the first row provides the support value for direct contact 404. In this example, direct contact 404 has a support value of 25%. The 25% support value indicates that direct contact 404 shares one out of the four secondary contacts with itself, where the number of secondary contacts corresponds to all secondary contacts 414, 416, 418, and 420 for direct contacts 404, 406, 408, 410, and 412. In another example, the row corresponding to direct contacts 406 and 410 has a support value of 50%. Returning to FIG. 4, it can be seen that each of direct contacts 406 and 410 are connected to secondary contacts 416 and 418. Since direct contacts 406 and 410 share two out of the four secondary contacts with one another, the support value is 50%. The support values for the remaining combination of direct contacts are similarly calculated, and the values are provided in the table above.

Once the support values have been calculated, the values are compared to the predetermined support value threshold. For the purpose of discussion, a support value threshold of 50% is assumed in this example. Using this threshold, the two frequent itemsets with the largest number of members are itemset group 422 and itemset group 424. As shown in FIG. 4, itemset group 422 includes direct contacts 408 and 412, and itemset group 424 includes direct contacts 406 and 410. If a threshold of 25% is assumed, then the frequent itemset with the largest number of members is itemset group 426, which includes direct contacts 406, 408, 410, and 412. In some aspects, frequent itemset mining allows the same item to appear in multiple itemsets since there is no restriction as to how many different social groups each direct contact may be added to. When the frequent itemset with the largest number of members have been identified, social groups may be suggested based on the identified itemsets. For example, a social group may be suggested for itemset group 422 as well itemset group 424, for a support value threshold of 50%. If a support value threshold of 25% is used, then a social group may be suggested for itemset group 426.

In some implementations, a minimum number of members criterion may further be used in identifying and suggesting a social group. Rather than suggesting a social group for the frequent itemset with the largest number of members, a social group may be suggested for frequent itemsets that satisfy the support value threshold as well as the minimum number of members criterion. For example, if a support value threshold of 25% is used, as in the above example, and a minimum number of members of three is applied, five different social groups will be suggested: 406, 408, and 410; 406, 408, and 412; 406, 410, and 412; 408, 410, and 412; and 406, 408, 410, and 412. Each of the five suggested social groups, as shown in the table above, have a support value of at least 25% and also have at least three members.

In some implementations, a suggestion for adding contacts to an existing group may be provided. When a large overlap between a proposed new social group and an existing group is identified, the proposed new social group may be added to the existing group. A threshold overlap percentage may be applied such that when an existing group includes more than the threshold overlap percentage of a proposed new social group, then the additional contacts of the proposed new social group are added to the existing group. For example, if direct contacts 406, 408 and 410 already belong to a social group for target user 402, rather than proposing a new social group that includes direct contacts 406, 408, 410 and 412 (which forms 75% of the proposed new social group), a suggestion to add direct contact 412 into the already existing social group may be provided. The suggestion of adding direct contact 412 is based on the premise that had direct contacts 406, 408, and 410 not already been in a social group, then a new social group of direct contacts 406, 408, 410, and 412 would have been suggested.

In some implementations, suggestions for contacts that already belong to a social group to be added to one or more additional social groups may be provided. As discussed above, frequent itemset mining allows the same item to appear in multiple itemsets since there is no restriction as to how many different social groups each direct contact may be added to. For example, an individual may have a social group that includes coworkers and a social group that includes college friends. While these two social groups are for two different sets of contacts, having a contact in one of the two social groups does not preclude the contact from being in the other social group. In some instances, the individual may have a college friend who also happens to be a colleague at work. Thus suggestions for contacts that already belong to a social group to be added to one or more additional social groups may be provided.

In some implementations, social groups may be automatically suggested for direct contacts that have been imported (e.g., from an email account or an address book), or manually added. When direct contacts are added via an import from an email account or address book, or manually by the user, the direct contacts generally do not have any associations with social groups. Thus, the user may be prompted with the suggestions to create new social groups, or to add new direct contacts to existing social groups. In some aspects, the suggestions may include one direct contact and one or more social groups suggested for the direct contact. Alternatively, the suggestion may include a social group including all the direct contacts suggested for the social group. When prompted, the user may accept, reject, or edit the suggestion. If the suggestion is accepted, then the corresponding direct contact(s) is/are added to the one or more social groups. If the suggestion is rejected, then the response is stored in order to prevent the same suggestion from being made in the future. If the suggestion is edited, then the corresponding direct contact(s) is/are added to the one or more social groups per the edit.

In some aspects, clique structures may be identified within a social graph, and the clique structure may be suggested as a social group. A clique may include direct contacts and secondary contacts of a target user who are connected to one another. The clique structure differs from the above-described suggested social groups because cliques may include direct contacts and secondary contacts, so long as each member of the clique is connected to a percentage of all the members of the clique that exceeds a predetermined threshold value. The social graph of clique structures may thus be identified via a modified frequent itemset mining analysis, where the denominator of the support value (i.e., the sample space of contacts through which direct contacts may be commonly connected to other direct contacts) includes not only secondary contacts to which the direct contact is connected to, but direct contacts as well.

In some implementations, additional web-based information may be used to refine the determination of the common set of direct contacts for which a social group is suggested. For example, user information such as electronic mail addresses (i.e., domain names associated with an electronic mail address), employer, organizations to which the user belongs, and schools attended may be used to refine the determination of the common set of primary contacts. If two contacts with support values that do not meet the threshold requirement but otherwise use common email domains in their work email address, such as abc.com, then the two contacts may be put into the same social group. Furthermore, user interactions corresponding to messaging services may also be used to determine interests of a user. For example, a set of users appearing in the same thread for a messaging service may be suggested as belonging to the same social group, again even if the combination of users does not satisfy the support value threshold requirement. In other words, contacts that would otherwise appear as outliers in a frequent itemset analysis may nonetheless be included in a suggested social group based on the web-based information.

In some aspects, a settings function may be provided to a user to limit the amount of information the user would like to be made available to the system for suggesting social groups. For example, if the user prefers to not have his connection to any other users known to non-contacts, the user may adjust the settings accordingly and opt out from providing that information. When a particular feature is turned off, the social group suggestions may be determined based on the remaining users that have not opted out.

In some aspects, a settings function may be provided to a user for selecting the external web-based sources which the user would like to have considered for suggesting social group events. For example, if a user prefers to not have any user interactions with a messaging service be taken into account for suggesting social group events, the user may adjust the settings accordingly and opt out of that particular feature. When a particular feature is turned off, the interest of a user may be determined based on the remaining features that the user has not opted out of.

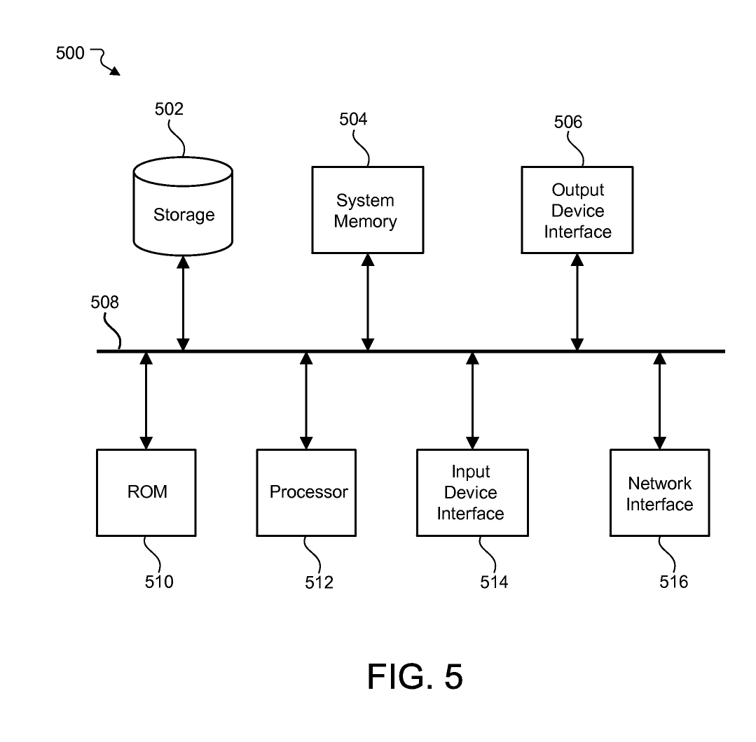

FIG. 5 conceptually illustrates an example electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for providing a suggested social group in a social networking service in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers, such as a local area network, a wide area network, or an Intranet, or a network of networks, such as the Internet. Any or all components of electronic system 500 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific computer implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

1. A computer-implemented method, the method comprising:
identifying a plurality of direct contacts connected to a user of a social networking service;
identifying a plurality of secondary contacts, wherein each of the plurality of secondary contacts is connected to at least one of the plurality of direct contacts;
determining a set of direct contacts from the plurality of direct contacts based on connections between the direct contacts and the secondary contacts; and
providing the set of direct contacts as a suggested social group.

2. The computer-implemented method of claim 1, wherein identifying the plurality of direct contacts comprises identifying contacts that are one hop away from the user on the social networking service, and wherein identifying the plurality of secondary contacts comprises identifying contacts that are two hops away from the user on the social networking service.

3. The computer-implemented method of claim 1, wherein determining the set of direct contacts comprises identifying direct contacts that share a number of the secondary contacts above a predetermined threshold.

4. The computer-implemented method of claim 1, wherein determining the set of direct contacts based on the plurality of secondary contacts comprises performing a frequent itemset mining analysis on the plurality of secondary contacts in relation to the plurality of direct contacts.

5. The computer-implemented method of claim 4, further comprising generating an inverted index for indicating support values for all possible combinations of direct contacts, wherein performing a frequent itemset mining analysis on the plurality of secondary contacts in relation to the plurality of direct contacts further comprises performing a frequent itemset mining analysis on the generated inverted index.

6. The computer-implemented method of claim 5, wherein determining the set of direct contacts based on connections between the direct contacts and the secondary contacts further comprises identifying two or more direct contacts with a corresponding support value greater than a predetermined threshold.

7. The computer-implemented method of claim 5, wherein determining the set of direct contacts based on connections between the direct contacts and the secondary contacts further comprises identifying two or more direct contacts with a number of common contacts greater than a predetermined value.

8. The computer-implemented method of claim 5, wherein determining the set of direct contacts based on the plurality of secondary contacts further comprises identifying, from all sets of direct contacts with a corresponding support value greater than a predetermined threshold, a set with a highest number of direct contacts.

9. The computer-implemented method of claim 5, wherein determining the set of direct contacts based on the plurality of secondary contacts further comprises identifying, from all sets of direct contacts with a corresponding support value greater than a predetermined threshold, a set with a number of direct contacts greater than a predetermined minimum number of contacts.

10. A non-transitory machine-readable medium comprising instructions stored therein, which when executed by a system, cause the system to perform operations comprising:
identifying a plurality of direct contacts connected to a user of a social networking service, wherein the plurality of direct contacts does not have associations with a social group;
identifying a plurality of secondary contacts, wherein each of the plurality of secondary contacts is connected to at least one of the plurality of direct contacts;
performing a frequent itemset mining analysis on the plurality of secondary contacts in relation to the plurality of direct contacts;
determining one or more sets of direct contacts from the plurality of direct contacts based on the performed frequent itemset mining analysis; and
providing the one or more sets of direct contacts as suggested social groups.

11. The non-transitory machine-readable medium of claim 10, wherein identifying the plurality of direct contacts comprises identifying contacts that are one hop away from the user on the social networking service, and wherein identifying the plurality of secondary contacts comprises identifying contacts that are two hops away from the user on the social networking service.

12. The non-transitory machine-readable medium of claim 10, wherein each of the plurality of secondary contacts is not directly connected to the user.

13. The non-transitory machine-readable medium of claim 10, further comprising instructions for generating an inverted index for indicating support values for all possible combinations of direct contacts, wherein instructions for performing a frequent itemset mining analysis on the plurality of secondary contacts in relation to the plurality of direct contacts further comprises instructions performing a frequent itemset mining analysis on the generated inverted index.

14. The non-transitory machine-readable medium of claim 13, wherein instructions for determining the one or more sets of direct contacts based on the performed frequent itemset mining analysis further comprises instructions for identifying one or more sets of direct contacts with corresponding support values greater than a predetermined threshold.

15. The non-transitory machine-readable medium of claim 14, wherein instructions for determining the one or more sets of direct contacts based on the performed frequent itemset mining analysis further comprises instructions for identifying, from the one or more sets, a set with a number of direct contacts greater than a predetermined value.

16. The non-transitory machine-readable medium of claim 13, wherein the support value corresponds to the number of secondary contacts commonly shared by the direct contacts.

17. The non-transitory machine-readable medium of claim 10, further comprising instructions for receiving a response for the suggested social groups.

18. The non-transitory machine-readable medium of claim 17, further comprising instructions for:
creating one or more new social groups based on the suggested groups when an affirmative response is received; and
storing the response in a memory when a negative response is received.

19. The non-transitory machine-readable medium of claim 18, wherein instructions for providing the one or more sets of direct contacts as suggested social groups further comprises instructions for checking the memory on which the negative response is stored, and providing the one or more sets of direct contacts as the suggested social groups only when no stored negative responses corresponding to the suggested social groups are identified.

20. A system comprising:
one or more processors; and
a machine-readable medium comprising instructions stored therein, which when executed by the processors, cause the processors to perform operations comprising:
identifying a plurality of direct contacts connected to a user of a social networking service, wherein each of the plurality of direct contacts is one hop away from the user on the social networking service;
identifying a plurality of secondary contacts, wherein each of the plurality of secondary contacts is connected to at least one of the plurality of direct contacts, and wherein each of the plurality of secondary contacts is two hops away from the user on the social networking service;
determining a set of direct contacts from the plurality of direct contacts based on connections between the direct contacts and the secondary contacts;
comparing the set of direct contacts with direct contacts of a preexisting social group; and
providing the set of direct contacts as a suggested addition to the preexisting social group when the set of direct contacts overlaps with direct contacts of the preexisting social group by a predetermined percentage.

21. The system of claim 20, wherein instructions for determining the set of direct contacts based on connections between the direct contacts and the secondary contacts further comprises instructions for performing a frequent itemset mining analysis on the plurality of secondary contacts in relation to the plurality of direct contacts.

22. The system of claim 21, further comprising instructions for generating an inverted index for indicating support values for all possible combinations of direct contacts, wherein instructions for determining the set of direct contacts based on the plurality of secondary contacts further comprises instructions for identifying a set of direct contacts with a corresponding support value greater than a predetermined threshold.
